(19) United States
(12) Patent Application Publication
(10) Pub. No.: US 2007/0086804 A1
(43) Pub. Date: Apr. 19, 2007

(54) Fusing device of electro-photographic image forming apparatus having temperature sensor protecting structure

(75) Inventor: Kwoang-joe Seorl, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/512,183

(22) Filed: Aug. 30, 2006

(30) Foreign Application Priority Data
Oct. 15, 2005 (KR) 2005-0097266

(51) Int. Cl. G03G 15/20

(52) U.S. Cl. 399/69

(57) ABSTRACT

A fusing device of an electro-photographic image forming apparatus is provided having a temperature sensor protecting structure. The fusing device includes a heat roller having a heater and a pressure roller rotating opposed to the heat roller. A temperature sensor housing accommodates a contact-type temperature sensor. A coil spring elastically presses the temperature sensor housing such that the contact-type temperature sensor contacts the outer circumferential surface of the heat roller.

### CROSS-REFERENCE TO RELATED PATENT APPLICATION

This application claims the benefit under 35 U.S.C. § 119(a) of Korean Patent Application No. 10-2005-0097266, filed on Oct. 15, 2005, in the Korean Intellectual Property Office, the entire disclosure of which is hereby incorporated by reference.

### BACKGROUND OF THE INVENTION

1. Field of the Invention

The present invention relates to a fusing device of an electro-photographic image forming apparatus. More particularly, the present invention relates to a fusing device of an electro-photographic image forming apparatus having a temperature sensor protecting structure that protects a contact-type temperature sensor and secures stable contact between the contact-type temperature sensor and a heat roller.

2. Description of the Related Art

Generally, an image forming apparatus, such as a laser beam printer, an LED printer, a digital copier, and a facsimile, transfers images to a sheet of paper as visible images in accordance with digital signals input from a computer or a scanner.

An electro-photographic image forming apparatus exposes digital signals indicating a desired image into a predetermined pattern, forms an electrostatic latent image corresponding to the desired image on the outer circumferential surface of a photoconductor, develops the latent image by the use of a powder-phase toner to form a toner image, and transfers and fuses the toner image to a sheet of paper directly or through a transfer medium.

The electro-photographic image forming apparatus includes a fusing device applying heat and pressure to the toner image transferred to the sheet of paper and fuses the toner image to the sheet of paper. FIG. 1 is an elevational view in cross section illustrating a fusing device of a conventional electro-photographic image forming apparatus. The fusing device 10 includes a pair of fusing rollers 11 and 13 rotating oppositely to each other and a case 15 receiving the pair of fusing rollers 11 and 13. The pair of fusing rollers 11 and 13 includes a combination of a heat roller 11 applying heat to a sheet of paper P by the use of a heater 12, such as a halogen lamp, and a pressure roller 13 that is pressed on the heat roller 11.

A temperature sensor 21 measuring a temperature of the heat roller 11 is provided on the outer circumferential portion of the heat roller 11 and the temperature sensor 21 is electrically connected to a controller (not shown). The controller controls the temperature of the heat roller 11 by transmitting a control signal to a power supply on the basis of the temperature signal measured by the temperature sensor 21 and controlling the power supplied to the heater 12.

A contact-type sensor, such as a thermistor, senses variations in resistance corresponding to variations in temperature and is mainly used as the temperature sensor 21. The contact-type temperature sensor 21 should maintain contact with the outer circumferential surface of the heat roller 11 and a leaf spring 22 of a cantilever type is generally used as a structure for maintaining the contact. That is, a sensor body 23 is disposed at one side of the case 15, an end of the leaf spring 22 is fixed to the sensor body 23, and the other end of the leaf spring 22 comes in elastic contact with the outer circumferential surface of the heat roller 11. The temperature sensor 21 is welded to the outside of the contact point between the leaf spring 22 and the heat roller 11.

However, such a structure has several disadvantages. First, when a jam occurs such that a sheet of paper is stopped in the fusing device 10, the leaf spring 22 may be damaged in the course of removing the jammed sheet. This is because the leaf spring 22 of a cantilever type has a narrow elastic deformation range and thus a permanent deformation can easily occur. When the temperature sensor 21 is separated from the outer circumferential surface of the heat roller 11, it is not possible to correctly sense the temperature, thereby causing overheating of the fusing rollers 11 and 13.

Second, because the temperature sensor 21 is disposed on the outer surface of the leaf spring 22 and thus is exposed to air, it is difficult to accurately measure a temperature. This is because the temperature sensor 21 is supplied with the heat of the outer circumferential surface of the heat roller 11 through the leaf spring 22 and is subjected to heat exchange with the outside air.

Accordingly, a need exists for an improved contact-type temperature sensor for a fusing device of an electro-photographic image forming apparatus.

### SUMMARY OF THE INVENTION

The present invention provides a fusing device of an electro-photographic image forming apparatus having a temperature sensor protecting structure that protects a contact-type temperature sensor, secures stable contact between the contact-type temperature sensor and a heat roller, and improves accuracy in measuring temperature.

According to an aspect of the present invention, a fusing device of an electro-photographic image forming apparatus comprises a heat roller having a heater, a pressure roller rotating opposed to the heat roller, a temperature sensor housing accommodating a contact-type temperature sensor, and a coil spring elastically pressing the temperature sensor housing such that the contact-type temperature sensor contacts the outer circumferential surface of the heat roller.

The temperature sensor housing may have a contact surface, formed along the contour of the outer circumferential surface of the heat roller and receives the contact-type temperature sensor to expose a surface of the contact-type temperature sensor from the contact surface. Additionally, the temperature sensor housing may be made of non-metal material and may surround the contact-type temperature sensor to substantially prevent the remaining surfaces of the contact-type temperature sensor from being exposed to external air.

The coil spring may include a compression coil spring, a tension coil spring, or a torsion coil spring. The coil springs may be selectively used depending upon the arrangement of the temperature sensor housing with respect to a case of the fusing device. However, the coil spring may have such an elasticity limit such that permanent deformation is not caused even when the temperature sensor housing is displaced a maximum amount within the case.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is an elevational view in cross section illustrating a fusing device of a conventional electro-photographic image forming apparatus;

FIG. 2 is an elevational view in cross section of an image forming apparatus adopting a fusing device according to an exemplary embodiment of the present invention;

FIG. 3 is an elevational view in cross section of a fusing device according to an exemplary embodiment of the present invention; and

FIG. 4 is a perspective view of a fusing device according to another exemplary embodiment of the present invention.

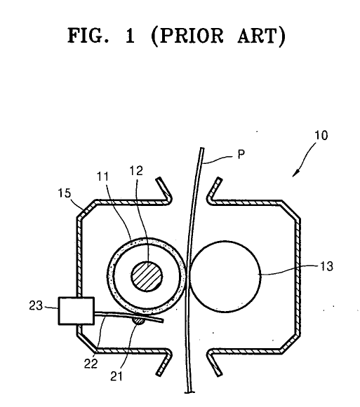

Throughout the drawings, like reference numerals will be understood to refer to like parts, components and structures.

### DETAILED DESCRIPTION OF EXEMPLARY EMBODIMENTS

Hereinafter, features of the present invention are described in detail with reference to the accompanying drawings.

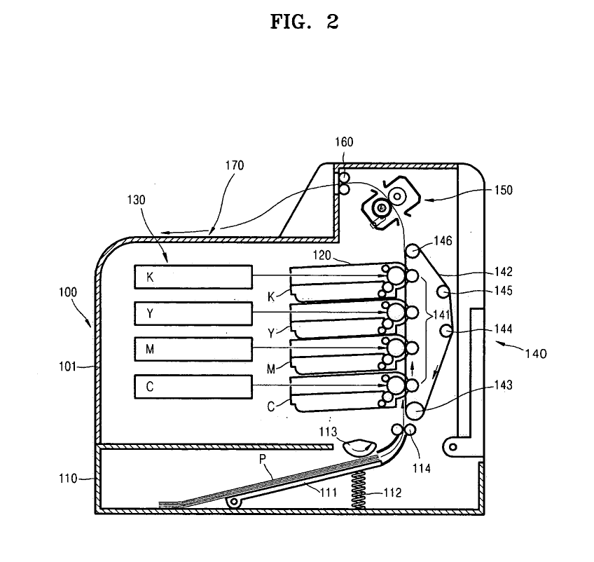

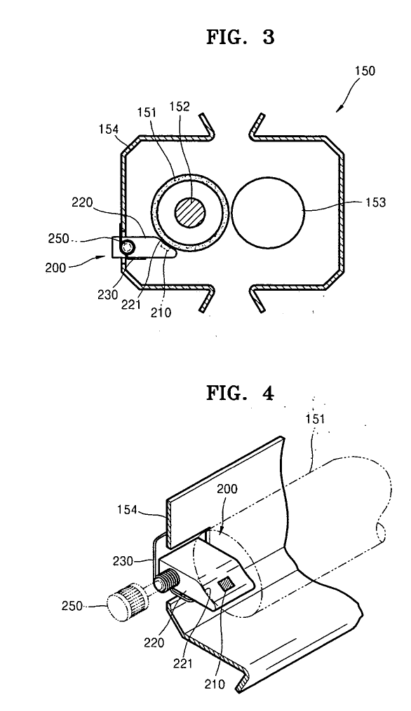

FIG. 2 is an elevational view in cross section of an image forming apparatus adopting a fusing device according to an exemplary embodiment of the present invention. FIG. 3 is an elevational view in cross section of a fusing device according to an exemplary embodiment of the present invention. Referring to FIG. 2, an image forming apparatus includes a printing unit 100 for printing an image on a paper sheet P using an electro-photographic process, and a cassette 110 in which paper sheets P are stacked.

The cassette 110 is detachably installed under a frame 101, and includes a plate 111 for supporting the paper sheets P and a spring 112 for applying upward elasticity to the plate 111. A pickup roller 113 for picking up the paper sheets P one by one is installed proximal the cassette 110. A paper sheet P picked up by the pickup roller 113 is transferred to the printing unit 100 by a transfer roller 114.

The printing unit 100 includes a developing cartridge 120, an exposer 130, a transfer unit 140, a fuser 150, and a discharge roller 160. The printing unit according to an exemplary embodiment of the present invention includes, for example, four developing cartridges 120C, 120M, 120Y, and 120K in which cyan (C) toner, magenta (M) toner, yellow (Y) toner, and black (K) toner are stored, to print a color image, and four exposers 130C, 130M, 130Y, and 130K corresponding to the developing cartridges 120C, 120M, 120Y, and 120K, respectively.

The transfer unit 140 includes transfer rollers 141C, 141M, 141Y, and 141K facing the developing cartridges 120C, 120M, 120Y, and 120K, respectively, and transferring toner to paper P, and a paper carrier belt 142 transferring the paper P transferred by the transfer roller 114. Paper P is attached to the surface of the paper carrier belt 142 using an electrostatic force while being rotated by a plurality of support rollers 143, 144, 145, and 146. As the paper P is transferred by the carrier belt 142, C, M, Y, and K toner images are sequentially transferred from the developing cartridges 120C, 120M, 120Y, and 120K onto the paper P to be overlapped with each other, whereby a color toner image is formed.

The fuser 150 is fixed to the frame 101, and fuses the color toner image formed on the paper P and attaches the same to the paper P by applying heat and pressure to the color toner image. The paper P onto which the fused toner image has been attached is discharged from the image forming apparatus by the discharge roller 160 and stacked on a discharge stand 170 installed on the frame 101.

Referring to FIG. 3, the fusing device 150 of an electro-photographic image forming apparatus according to an exemplary embodiment of the present invention includes a pair of fusing rollers 151 and 153 rotating opposed to each other and a case 154 accommodating the pair of fusing rollers 151 and 153. The pair of fusing rollers 151 and 153 generally includes a combination of a heat roller 151 applying heat to a sheet of paper P by the use of a heater 152, such as a halogen lamp, and a pressure roller 153 being pressed and being in close contact with the heat roller 151. The case 154 is fixed to a frame of the electro-photographic image forming apparatus and substantially prevents heat generated in the heat roller 151 from being externally radiated.

A temperature sensor protecting structure 200 includes a contact-type temperature sensor 210 and is disposed inside the case 154. The temperature sensor protecting structure 200 includes a temperature sensor housing 220 accommodating the contact-type temperature sensor 210 and a coil spring 230 elastically pressing the temperature sensor housing 220 such that the contact-type temperature sensor 210 contacts the outer circumferential surface of the heat roller 151.

The temperature sensor housing 220 has a contact surface 221 substantially corresponding to the contour of the outer circumferential surface of the heat roller 151 and that accommodates the contact-type temperature sensor 210, such as a thermistor, in a groove in the contact surface 221. The temperature sensor housing 220 is provided at one side of the case 154 to be rotatable about an axis substantially parallel to the axis of the heat roller 151 and is elastically pressed by the coil spring, such as a torsion coil spring, such that the contact surface 221 is in close contact with the outer circumferential surface of the heat roller 151.

The connection type between the temperature sensor housing 220 and the case 154 and the type of the coil spring 230 are not limited to the above-mentioned exemplary embodiment. Preferably, the contact surface 221 of the temperature sensor housing 220 is made of a non-metal material, such as, for example, a heat-resistant plastic material having a thermal deformation temperature of about 200° C. or more. The contact surface may have a conductivity lower than that of metal and may be formed such that the groove receiving the temperature sensor 210 surrounds the surfaces other than the surface where the temperature sensor 210 contacts the heat roller. The coil spring 230 may have such an elasticity limit that permanent deformation is not caused even when the temperature sensor housing 220 is displaced a maximum amount within the case 154. The coil spring may be of any suitable type, such as a torsion coil spring, a compression coil spring, or a tension coil spring, based on the connection type between the temperature sensor housing 220 and the case 154.

According to the structure described above, even when an abnormal force acts on the temperature sensor housing 220 in the course of removing a paper jam generated in the fusing device, the temperature sensor is substantially prevented from being permanently separated from the surface of the heat roller 151. Additionally, because the temperature sensor housing 220 surrounds the temperature sensor 210, an error in measuring a temperature due to the loss of heat is reduced.

Because the area in which the temperature sensor housing 220 and the outer circumferential surface of the heat roller 151 contact each other is large and thus the pressure acting on the heat roller 151 at the contact portion therebetween is small, damage on the outer circumferential surface of the heat roller 151 is reduced.

The fusing device 100 according to exemplary embodiments of the present invention may further include a compulsory separation unit 250 compulsorily separating the temperature sensor unit 220 from the heat roller 151. The compulsory separation member 250 may be activated to easily remove a jammed sheet when a jam occurs in the fusing device. Additionally, damage due to abnormal friction between the temperature sensor housing 220 and the heat roller 151 is substantially prevented.

The compulsory separation unit 250 may be a motor that is connected to the temperature sensor housing 220 and automatically or manually operates when a paper jam occurs. Alternatively, the compulsory separation unit may be a mechanism having the motor. Alternatively, the compulsory separation unit 250 may be a mechanism that is connected to a cover of the image forming apparatus and operates when the cover is opened to remove a paper jam.

FIG. 4 is a perspective view illustrating a fusing device according to another exemplary embodiment of the present invention. As shown in FIG. 4, the temperature sensor housing 220 has a contact surface 221 corresponding to the outline of the outer circumferential surface of the heat roller 151 and receives the temperature sensor 210 in a portion of the contact surface 221 to expose a surface of the temperature sensor 210 at substantially the same height approximately equal to that of the contact surface 221.

The coil spring 230 is a torsion coil spring of which one end is supported by the case 154 and the other end applies a force to the temperature sensor housing 220. The coil spring 230 may have such an elasticity limit that permanent deformation is not caused even when the temperature sensor housing 220 is separated from the heat roller 151 and rotates to the extent that the temperature sensor housing 220 contacts the case 154. Additionally, the coil spring 230 may have a spring index of about 4 to 15 to have sufficient durability in consideration of the lifetime of the fusing device.

In the fusing device of an electro-photographic image forming apparatus having the temperature sensor protecting structure according to exemplary embodiments of the present invention, the contact-type temperature sensor is protected, stable contact between the contact-type temperature sensor and the heat roller is secured, and accuracy in measuring a temperature is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A fusing device of an electro-photographic image forming apparatus, the fusing device comprising:
a heat roller having a heater;
a pressure roller rotating opposed to the heat roller;
a temperature sensor housing accommodating a contact-type temperature sensor; and
a coil spring elastically pressing the temperature sensor housing such that the contact-type temperature sensor contacts an outer circumferential surface of the heat roller.

2. The fusing device of claim 1, wherein the temperature sensor housing has a contact surface substantially corresponding to the contour of the outer circumferential surface of the heat roller and accommodating the contact-type temperature sensor such that a surface of the contact-type temperature sensor is exposed from the contact surface.

3. The fusing device of claim 2, wherein the temperature sensor housing is made of a non-metal material and surrounds the contact-type temperature sensor to substantially prevent the remaining surfaces of the contact-type temperature sensor from being exposed to external air.

4. The fusing device of claim 1, wherein the temperature sensor housing is rotatable about an axis substantially parallel to an axis of the heat roller.

5. The fusing device of claim 4, wherein the coil spring is a torsion coil spring having a center at the axis of the temperature sensor housing.

6. The fusing device of claim 1, further comprising a compulsory separation unit compulsorily separating the temperature sensor housing from the heat roller within an elastic deformation range of the coil spring.

7. The fusing device of claim 6, wherein the compulsory separation unit is actuated when removing a paper jam in the fusing device.

8. The fusing device of claim 3, wherein the temperature sensor housing is made of a heat-resistant plastic material.

9. The fusing device of claim 1, wherein the coil spring is selected from the group consisting of a torsion coil spring, a compression coil spring, and a tension coil spring.

10. A fusing device of an electro-photographic image forming apparatus, the fusing device comprising:
a heat roller having a heater;
a pressure roller rotating opposed to the heat roller;
a case accommodating the heat roller and the pressure roller;
a temperature sensor housing accommodating a contact-type temperature sensor; and
a coil spring elastically pressing the temperature sensor housing such that the contact-type temperature sensor contacts the outer circumferential surface of the heat roller,
wherein the coil spring has an elasticity limit such that permanent deformation is substantially not caused when the temperature sensor housing is displaced a maximum amount within the case.

11. The fusing device of claim 10, wherein the temperature sensor housing has a contact surface substantially corresponding to the contour of an outer circumferential surface of the heat roller and accommodates the contact-type temperature sensor such that a surface of the contact-type temperature sensor is exposed from the contact surface.

12. The fusing device of claim 11, wherein the temperature sensor housing is made of a non-metal material and surrounds the contact-type temperature sensor to substantially prevent the remaining surfaces of the contact-type temperature sensor from being exposed to external air.

13. The fusing device of claim 10, wherein the temperature sensor housing is disposed in the case to be rotatable about an axis substantially parallel to an axis of the heat roller.

14. The fusing device of claim 13, wherein the coil spring is a torsion coil spring having a center at the axis of the temperature sensor housing.

15. The fusing device of claim 10, further comprising a compulsory separation unit compulsorily separating the temperature sensor housing from the heat roller within an elastic deformation range of the coil spring.

16. The fusing device of claim 15, wherein the compulsory separation unit is actuated when removing a paper jam in the fusing device.

17. The fusing device of claim 12, wherein the temperature sensor housing is made of a heat-resistant plastic material.

18. The fusing device of claim 10, wherein the coil spring is selected from the group consisting of a torsion coil spring, a compression coil spring, and a tension coil spring.

19. An image forming apparatus, comprising:
a frame;
a fusing device connected to the frame for fusing a toner image on a printing medium, the fusing device including
a heat roller having a heater;
a pressure roller rotating opposed to the heat roller;
a temperature sensor housing accommodating a contact-type temperature sensor; and
a coil spring elastically pressing the temperature sensor housing such that the contact-type temperature sensor contacts an outer circumferential surface of the heat roller.

20. An image forming apparatus according to claim 19, wherein the temperature sensor housing has a contact surface substantially corresponding to the contour of the outer circumferential surface of the heat roller and accommodating the contact-type temperature sensor such that a surface of the contact-type temperature sensor is exposed from the contact surface.

21. An image forming apparatus according to claim 20, wherein the temperature sensor housing is made of a non-metal material and surrounds the contact-type temperature sensor to substantially prevent the remaining surfaces of the contact-type temperature sensor from being exposed to external air.

22. An image forming apparatus according to claim 19, wherein the temperature sensor housing is rotatable about an axis substantially parallel to an axis of the heat roller.

23. An image forming apparatus according to claim 22, wherein the coil spring is a torsion coil spring having a center at the axis of the temperature sensor housing.

24. An image forming apparatus according to claim 19, further comprising a compulsory separation unit compulsorily separating the temperature sensor housing from the heat roller within an elastic deformation range of the coil spring.

25. An image forming apparatus according to claim 24, wherein the compulsory separation unit is actuated when removing a paper jam in the fusing device.

26. An image forming apparatus according to claim 21, wherein the temperature sensor housing is made of a heat-resistant plastic material.

27. An image forming apparatus according to claim 19, wherein the coil spring is selected from the group consisting of a torsion coil spring, a compression coil spring, and a tension coil spring.
